(19) United States
(12) Patent Application Publication
(10) Pub. No.: US 2013/0082639 A1
(43) Pub. Date: Apr. 4, 2013

(54) ELECTRICAL SYSTEM HAVING A PRIMARY ENERGY SOURCE AND A REDUNDANT RECHARGEABLE ENERGY SOURCE

(71) Applicants: JAMES C. O'KANE, SHELBY TOWNSHIP, MI (US); RICHARD J. LANGE, TROY, MI (US)

(72) Inventors: JAMES C. O'KANE, SHELBY TOWNSHIP, MI (US); RICHARD J. LANGE, TROY, MI (US)

(73) Assignee: GM GLOBAL TECHNOLOGY OPERATIONS LLC, DETROIT, MI (US)

(21) Appl. No.: 13/252,812

(22) Filed: Oct. 4, 2011

(51) Int. Cl. H02J 7/00; H02J 4/00

(52) U.S. Cl. 320/104; 320/128; 320/103; 320/166; 307/44

(57) ABSTRACT

Presented here is an electrical system for a vehicle having an electrical load. The electrical system includes a primary energy source, a rechargeable redundant energy source coupled to the primary energy source via a first switch, a second switch, a third switch, a fourth switch, and a control unit. The fourth switch is coupled between the electrical load and the second switch, and is coupled between the electrical load and the third switch. The control unit operates the first switch to facilitate charging of the rechargeable redundant energy source with the primary energy source, operates the second switch and the third switch in concert to selectively provide operating power from either the primary energy source or the rechargeable redundant energy source to the fourth switch, and operates the fourth switch to provide the operating power to the electrical load.

### TECHNICAL FIELD

Embodiments of the subject matter described herein relate generally to electrical systems. More particularly, embodiments of the subject matter relate to a vehicle electrical system having a primary energy source and a redundant or backup energy source for providing operating power to a vehicle subsystem.

### BACKGROUND

Electrical components, systems, and subsystems are used in a vast number of applications. Modern vehicles have become increasingly dependent on electrical devices and loads, such as those related to entertainment systems, navigation systems, window actuators, door latching and locking, stability control systems, etc. Redundant or backup power supplies are often used with important or critical electrical systems. For example, a server computer may include a backup power supply such as a battery that serves as an emergency energy source in the event of loss or disruption of the main AC outlet power.

Backup power sources may also be used in a vehicle. Traditionally, backup power sources onboard a vehicle are used when the main power source fails or becomes depleted of energy. For example, a backup battery could remain on standby until the main battery starts to lose its charge. Although this approach may be adequate for many situations, it may be undesirable for use with critical electrical systems or components, especially if the backup supply is susceptible to failure. For example, an electric ignition or electric unlatching system of a vehicle should use a highly reliable and trustworthy backup energy source. If for some reason the backup energy source has discharged, failed, or is otherwise unable to provide sufficient operating energy, then such critical subsystems will be inoperable.

### BRIEF SUMMARY

An exemplary embodiment of an electrical system is presented here. The electrical system includes a primary energy source for an electrical load, and a rechargeable energy source for the electrical load. The electrical system also includes a first switch, a second switch, and a third switch. The first switch is coupled between the primary energy source and the rechargeable energy source, wherein activation of the first switch facilitates charging of the rechargeable energy source with the primary energy source. The second switch is coupled between the primary energy source and the electrical load. The third switch is coupled between the rechargeable energy source and the electrical load. The electrical system also includes a control unit to operate the second switch and the third switch such that by default the primary energy source is decoupled from the electrical load and the rechargeable energy source is coupled to the electrical load to provide operating power to the electrical load, and such that under a degraded performance condition associated with the rechargeable energy source the rechargeable energy source is decoupled from the electrical load and the primary energy source is coupled to the electrical load to provide operating power to the electrical load.

Also provided is an electrical system for a vehicle having an electrical load. The electrical system includes: a primary energy source; a rechargeable redundant energy source coupled to the primary energy source via a first switch; a second switch; a third switch; a fourth switch coupled between the electrical load and the second switch, and coupled between the electrical load and the third switch; and a control unit. The control unit operates the first switch to facilitate charging of the rechargeable redundant energy source with the primary energy source, and operates the second switch and the third switch in concert to selectively provide operating power from either the primary energy source or the rechargeable redundant energy source to the fourth switch. The control unit also operates the fourth switch to provide the operating power to the electrical load.

A method of providing operating power to an electrical load of a vehicle is also provided. The method configures a switch architecture to provide operating power from a rechargeable energy source to the electrical load when performance characteristics of the rechargeable energy source are satisfactory. The method continues by detecting when the performance characteristics of the rechargeable energy source are unsatisfactory. In response to detecting that the performance characteristics of the rechargeable energy source are unsatisfactory, the method reconfigures the switch architecture to provide operating power from a primary energy source to the electrical load.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic representation of an exemplary embodiment of an electrical system; and

FIG. 2 is a schematic representation of an exemplary embodiment of an electrical system deployed in a vehicle.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

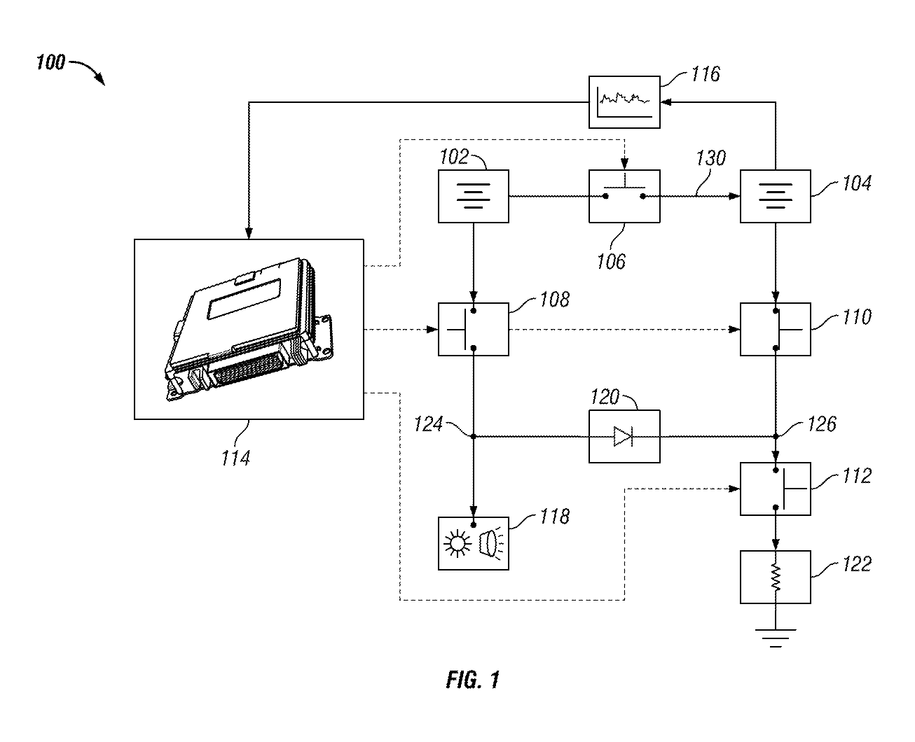

FIG. 1 is a schematic representation of an exemplary embodiment of an electrical system 100. The electrical system 100 may be deployed in any number of practical applications, e.g., in a dwelling or other building, in an appliance or piece of machinery, in a computing device or system, in a vehicle, or the like. The non-limiting exemplary embodiment described here relates to an implementation onboard a vehicle, i.e., a vehicle electrical system.

The electrical system 100 is based upon two distinct and different energy sources: a primary energy source 102 and a redundant (or backup) rechargeable energy source 104. The exemplary embodiment of the electrical system 100 includes a switch architecture having a plurality of switches: a first switch 106; a second switch 108; a third switch 110; and a fourth switch 112. The electrical system 100 may also include, without limitation: a control unit 114; a monitor unit 116; a warning system 118; and a diode 120. The electrical system 100 is configured and controlled in an appropriate manner to provide operating power to an electrical load 122.

The primary energy source 102 may be any source, supply, or provider of electrical energy. In certain embodiments, the primary energy source 102 is an AC energy source, such as a mains power supply. For the vehicle based implementation described here, the primary energy source 102 is a DC energy source. In this regard, the primary energy source 102 may include, without limitation: a battery; a fuel cell; a capacitor; or any type of electricity generating system. Moreover, the primary energy source 102 could be implemented as a combination of different energy-providing components. For the exemplary vehicle based embodiment described here, the primary energy source 102 may be the main vehicle battery (e.g., a standard twelve volt battery or a high voltage battery of the type used in hybrid or fully electric vehicles) that is maintained and charged with one or more onboard recharging systems such as a traditional engine powered generator, a regenerative braking system, or the like.

The rechargeable energy source 104 may be any rechargeable or replenishable source, supply, or provider of electrical energy. In practice, the rechargeable energy source 104 could be a rechargeable battery or battery pack, a capacitor or supercapacitor, or the like. For the vehicle based embodiment described here, the rechargeable energy source 104 is a rechargeable battery having an appropriate chemistry.

The electrical characteristics and specifications of the primary energy source 102 and the rechargeable energy source 104 are selected for compatibility and utility with the intended electrical load 122. In other words, the energy sources 102, 104 are suitably configured to provide operating power for the electrical load 122. For this particular example, the electrical load 122 represents an onboard system or subsystem of the vehicle, such as an electric unlatching system associated with one or more doors, a compartment, a deck lid, a hood, or the like.

In accordance with the illustrated embodiment of the electrical system 100, the first switch 106 is coupled between the primary energy source 102 and the rechargeable energy source 104, the second switch 108 is coupled between the primary energy source 102 and a node 124, the third switch 110 is coupled between the rechargeable energy source 104 and a node 126, and the fourth switch 112 is coupled between the node 126 and the electrical load 122. Moreover, the diode 120 is coupled between the nodes 124, 126. Consequently, the second switch 108 is indirectly coupled to the fourth switch 112 via the diode 120. Thus, the second switch 108 is coupled between the primary energy source 102 and the electrical load 122, and the third switch 110 is coupled between the rechargeable energy source 104 and the electrical load 122.

For this particular embodiment, the monitor unit 116 is coupled to the rechargeable energy source 104 to monitor at least one performance characteristic of the rechargeable energy source 104. In this regard, the monitor unit 116 may monitor, measure, or detect a voltage, current, temperature, resistance, capacitance, and/or state of charge of the rechargeable energy source 104 at various times during the lifespan of the rechargeable energy source 104. This allows the monitor unit 116 to detect whether or not the rechargeable energy source 104 is performing in a satisfactory or unsatisfactory manner for purposes of supporting the electrical load 122. For example, the monitor unit 116 can generate an appropriate signal, message, or notification to the control unit 114 when it detects a degraded performance condition associated with the rechargeable energy source 104. A degraded performance condition may be, for example, a condition wherein the rechargeable energy source 104 is no longer able to maintain a sufficient charge even when the first switch 106 is closed, or able to maintain a sufficient charge shortly after the first switch 106 is opened.

The control unit 114 may be coupled to control the activation and operation of the switches 106, 108, 110, 112 as needed. The control unit 114 may include or be implemented with a general purpose processor, a content addressable memory, a digital signal processor, an application specific integrated circuit, a field programmable gate array, any suitable programmable logic device, discrete gate or transistor logic, discrete hardware components, or any combination designed to perform the functions described here. A processor device may be realized as a microprocessor, a controller, a microcontroller, or a state machine. Moreover, a processor device may be implemented as a combination of computing devices, e.g., a combination of a digital signal processor and a microprocessor, a plurality of microprocessors, one or more microprocessors in conjunction with a digital signal processor core, or any other such configuration. In a typical vehicle deployment, the control unit 114 may be realized as an electrical control unit (ECU) that is compatible with the control network or architecture of the vehicle.

The warning system 118 may be coupled to the second switch 108 to obtain operating power from the primary energy source 102 when the second switch 108 is activated. The warning system 118 is suitably configured to generate an alert, alarm, message, or other notification in response to the detection of a degraded performance condition of the rechargeable energy source 104. Thus, the warning system 118 can generate an alert for the user of the vehicle to indicate that the performance characteristics of the rechargeable energy source 104 have become unsatisfactory and that the rechargeable energy source 104 should be serviced, repaired, or replaced in the near future.

FIG. 1 depicts the default or normal operating condition of the electrical system 100, e.g., when the engine of the vehicle is turned off and the vehicle is stationary. For this exemplary embodiment, the first switch 106 is “normally open” and it closes when activated. Activation (closure) of the first switch 106 facilitates charging of the rechargeable energy source 104 with the primary energy source 102. In this regard, the arrow 130 in FIG. 1 represents charging voltage or current of the primary energy source 102 that can be used for purposes of charging the rechargeable energy source 104. Activation of the first switch 106 may be regulated by the control unit 114, which in turn may be responsive to one or more triggering events. For example, the first switch 106 could be activated in response to a user command, such as the manipulation of a user interface, a button, or the like. As another example, the first switch 106 could be activated by the control unit 114 when the engine of the vehicle is operating or running (which in turn may be indicative of a state during which the primary energy source 102 is being charged by an engine driven generator).

In certain embodiments, the control unit 114 controls the second switch 108 and the third switch 110 in concert. The second switch 108 is “normally open” and it closes when activated; the third switch 110 is “normally closed” and it opens when activated. These two switches are activated/deactivated together such that only one is open (and, conversely, the other is closed) at any given time. In accordance with the state depicted in FIG. 1, by default the control unit 114 holds the second switch 108 open and the third switch 110 closed so that the primary energy source 102 is decoupled from the electrical load 122 and the rechargeable energy source 104 is coupled to the electrical load 122 to provide operating power to the electrical load 122. Thus, under normal conditions wherein the rechargeable energy source 104 is performing in a satisfactory manner, the input to the fourth switch 112 is electrically connected to the rechargeable energy source 104. In other words, the control unit 114 configures the switch architecture of the electrical system 100 to provide operating power from the rechargeable energy source 104 to the electrical load when performance characteristics of the rechargeable energy source are satisfactory.

It should be appreciated that activation of the first switch 106 and activation of the fourth switch 112 may be performed independently of each other and independently of the switches 108, 110. Indeed, the fourth switch 112 need not be activated until the electrical load 122 need to be driven or until the electrical system 100 otherwise decides that operating power needs to be provided to the electrical load 122.

As mentioned above, the monitor unit 116 checks the rechargeable energy source 104 to determine whether or not it can support the normal operating requirements of the electrical load 122. For example, if the energy of the rechargeable energy source 104 has been depleted beyond a threshold amount, then the monitor unit 116 can notify the control unit 114, which in turn can activate the switches 108, 110 to connect the primary energy source 102 to the fourth switch 112. As another example, if the rechargeable energy source 104 has aged to the point where it can no longer retain a satisfactory charge for purposes of supporting the electrical load 122, then the monitor unit 116 can notify the control unit 114 so that appropriate action can be taken.

In response to the detection of unsatisfactory performance characteristics of the rechargeable energy source 104, the control unit 114 reconfigures the switch architecture of the electrical system 100 to provide operating power from the primary energy source 102 to the electrical load 122. In practice, the electrical system 100 uses energy provided by the primary energy source 102 when configuring and reconfiguring the switch architecture. This methodology assumes that the primary energy source 102 can provide the necessary operating power to activate the switches even though the rechargeable energy source 104 may be depleted or operating below its minimum specifications.

To transition from the normal state shown in FIG. 1 to a “backup” state, the control unit 114 operates the second switch 108 in concert with the third switch 110 such that the rechargeable energy source 104 is disconnected from the fourth switch 112, and such that the primary energy source 102 is connected to the fourth switch 112. This configuration allows the primary energy source 102 to provide operating power to the electrical load 122 as needed. By changing the configuration of the switch architecture in this manner, the electrical system 100 can selectively provide operating power to the electrical load 122 (via the fourth switch 112) from either the rechargeable energy source 104 or the primary energy source 102.

Closure of the second switch 108 also provides operating power to the warning system 118, thus enabling the warning system 118 to generate an alert as described above. Notably, the “backup” configuration of the electrical system 100 can be maintained for as long as the rechargeable energy source 104 remains in an unsatisfactory state. When the rechargeable energy source 104 is replaced, repaired, recharged, or otherwise brought back to a satisfactory operating state, the monitor unit 116 will detect the satisfactory condition and notify the control unit 114 in an appropriate manner. Thereafter, the control unit 114 can return the switch architecture back to the state depicted in FIG. 1 to again rely on the rechargeable energy source 104 rather than the primary energy source 102.

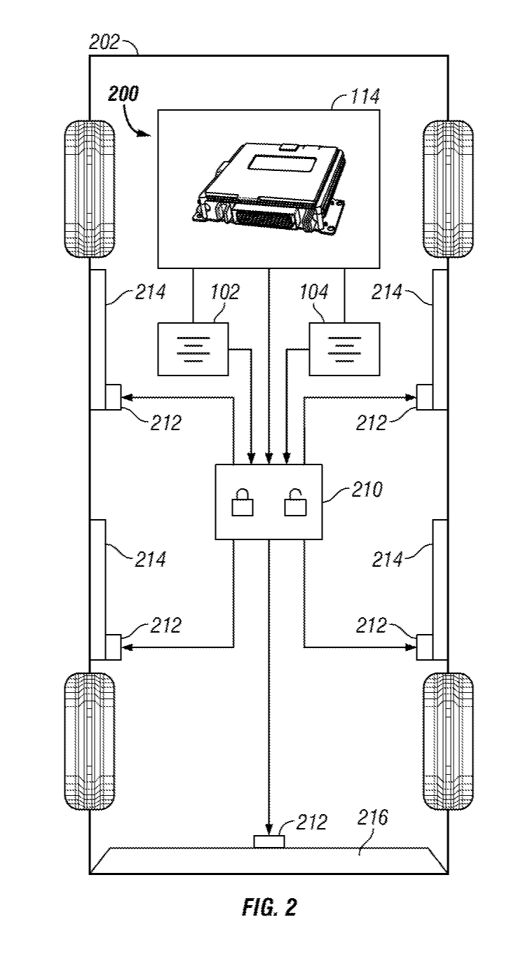

As mentioned previously, the electrical system 100 can be deployed in the context of a vehicle such as a conventional, hybrid, or fully electric automobile. In this regard, FIG. 2 is a schematic representation of an exemplary embodiment of an electrical system 200 deployed in a vehicle 202. The electrical system 200 depicted in FIG. 2 has been simplified, and FIG. 2 does not show the same amount of detail shown in FIG. 1. Nonetheless, the embodiment of the electrical system 200 depicted in FIG. 2 preferably includes at least the same elements (or their equivalents) of the electrical system 100.

This particular embodiment of the electrical system 200 includes the control unit 114, the primary energy source 102, and the rechargeable energy source 104, which are coupled to an electric unlatching system 210 of the vehicle 202. Although not depicted in FIG. 2, the electrical system 200 include a suitably configured switch architecture (as described above for the electrical system 100) to selectively connect either the primary energy source 102 or the rechargeable energy source 104 to the electric unlatching system 210.

The electric unlatching system 210 may include any number of electrically actuated latches 212 distributed throughout the vehicle 202. FIG. 2 shows five electrically actuated latches 212, which respectively correspond to four passenger doors 214 and a trunk 216 (or deck lid) of the vehicle 202. More or less than five latches 212 could be deployed in an embodiment of the vehicle 202. The electric unlatching system 210 may control the latching (locking) and unlatching (unlocking) of the electrically actuated latches 212, using power supplied by either the primary energy source 102 or the rechargeable energy source 104. In a typical scenario, a user activates the electric unlatching system 210 to unlock the vehicle 202. The electrical system 200 is designed such that the electric unlatching system 210 can be operated even though the rechargeable energy source 104 has failed or is otherwise in an unsatisfactory condition. Accordingly, the design of the electrical system 200 reduces the likelihood of a “lockout” situation and improves the reliability and readiness of the electric unlatching system 210.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. An electrical system comprising:
a primary energy source for an electrical load;
a rechargeable energy source for the electrical load;
a first switch coupled between the primary energy source and the rechargeable energy source, wherein activation of the first switch facilitates charging of the rechargeable energy source with the primary energy source;
a second switch coupled between the primary energy source and the electrical load;
a third switch coupled between the rechargeable energy source and the electrical load; and
a control unit to operate the second switch and the third switch such that by default the primary energy source is decoupled from the electrical load and the rechargeable energy source is coupled to the electrical load to provide operating power to the electrical load, and such that under a degraded performance condition associated with the rechargeable energy source the rechargeable energy source is decoupled from the electrical load and the primary energy source is coupled to the electrical load to provide operating power to the electrical load.

2. The electrical system of claim 1, wherein the primary energy source comprises a battery.

3. The electrical system of claim 1, wherein the rechargeable energy source comprises a rechargeable battery.

4. The electrical system of claim 1, further comprising a monitor unit to monitor at least one performance characteristic of the rechargeable energy source.

5. The electrical system of claim 4, wherein the monitor unit monitors state of charge of the rechargeable energy source.

6. The electrical system of claim 4, wherein the monitor unit detects the degraded performance condition associated with the rechargeable energy source.

7. The electrical system of claim 1, wherein:
the primary energy source comprises a primary battery of a vehicle;
the rechargeable energy source comprises a redundant battery of the vehicle; and
the first switch is activated to facilitate charging of the redundant battery of the vehicle when an engine of the vehicle is operating.

8. The electrical system of claim 7, wherein the electrical load comprises an electric unlatching system of the vehicle.

9. An electrical system for a vehicle having an electrical load, the electrical system comprising:
a primary energy source;
a rechargeable redundant energy source coupled to the primary energy source via a first switch;
a second switch;
a third switch;
a fourth switch coupled between the electrical load and the second switch, and coupled between the electrical load and the third switch; and
a control unit to operate the first switch to facilitate charging of the rechargeable redundant energy source with the primary energy source, to operate the second switch and the third switch in concert to selectively provide operating power from either the primary energy source or the rechargeable redundant energy source to the fourth switch, and to operate the fourth switch to provide the operating power to the electrical load.

10. The electrical system of claim 9, wherein the rechargeable redundant energy source comprises a capacitor.

11. The electrical system of claim 9, further comprising a monitor unit to monitor at least one performance characteristic of the rechargeable redundant energy source.

12. The electrical system of claim 9, wherein:
the control unit operates the second switch and the third switch in concert such that by default the primary energy source is disconnected from the fourth switch, and the rechargeable redundant energy source is connected to the fourth switch to provide operating power to the electrical load; and
the control unit operates the second switch and the third switch in concert such that under a degraded performance condition associated with the rechargeable redundant energy source the rechargeable redundant energy source is disconnected from the fourth switch, and the primary energy source is connected to the fourth switch to provide operating power to the electrical load.

13. The electrical system of claim 12, further comprising a warning system to generate an alert in response to detection of the degraded performance condition.

14. The electrical system of claim 13, wherein the warning system is coupled to the second switch such that when the second switch is activated the primary energy source provides operating power to the warning system.

15. The electrical system of claim 9, wherein the electrical load comprises an electric unlatching system of the vehicle.

16. A method of providing operating power to an electrical load of a vehicle, the method comprising:
configuring a switch architecture to provide operating power from a rechargeable energy source to the electrical load when performance characteristics of the rechargeable energy source are satisfactory;
detecting when the performance characteristics of the rechargeable energy source are unsatisfactory; and
in response to detecting that the performance characteristics of the rechargeable energy source are unsatisfactory, reconfiguring the switch architecture to provide operating power from a primary energy source to the electrical load.

17. The method of claim 16, further comprising:
configuring the switch architecture to facilitate charging of the rechargeable energy source with the primary energy source.

18. The method of claim 17, further comprising:
charging the rechargeable energy source with the primary energy source when an engine of the vehicle is running; and
providing operating power to the electrical load when the engine is not running.

19. The method of claim 16, further comprising:
generating an alert in response to detecting that the performance characteristics of the rechargeable energy source are unsatisfactory.

20. The method of claim 16, wherein configuring the switch architecture and reconfiguring the switch architecture are performed using energy provided by the primary energy source.
